(19) United States
(12) Patent Application Publication
(10) Pub. No.: US 2026/0160172 A1
(43) Pub. Date: Jun. 11, 2026

(54) TURBOMACHINE MODULE EQUIPPED WITH VARIABLE PITCH VANES AND OIL TRANSFER DEVICE

(71) Applicant: SAFRAN AIRCRAFT ENGINES, Paris (FR)

(72) Inventors: Caroline Marie FRANTZ, Moissy-Cramayel (FR); Julien Fabien Patrick BECOULET, Moissy-Cramayel (FR); Vincent Francois Georges MILLIER, Moissy-Cramayel (FR); Jean Charles Olivier RODA, Moissy-Cramayel (FR)

(21) Appl. No.: 18/718,406

(22) PCT Filed: Dec. 13, 2022
(86) PCT No.: PCT/FR2022/052327

§ 371 Date: Jun. 10, 2024

(30) Foreign Application Priority Data
Dec. 20, 2021 (FR) FR2113952

(51) Int. Cl. F01D 7/00; F01D 15/12; F01D 25/16

(52) U.S. Cl. CPC F01D 7/00; F01D 15/12; F01D 25/16; F05D 2220/36; F05D 2240/50; F05D 2260/40311

(57) ABSTRACT

A turbomachine module, including fan comprising variable pitch fan vanes, a speed reducer connected to a fan shaft which is guided in rotation by two first and a second rolling guide bearings, a pitch change system for the vanes including a controller including an annular body integral with the fan shaft and a movable body, a fluid transfer device intended to feed the control means. The speed reducer has a planetary gear train, and the transfer device is arranged upstream of the speed reducer and includes a stator portion and a rotor portion engaged in the stator portion, the rotor portion being integral in rotation with the annular body of the controller which is arranged upstream of the first and second guide bearings.

### TECHNICAL FIELD OF THE INVENTION

The present invention relates to the field of aircraft turbomachines. It is aimed in particular at a turbomachine module comprising variable pitch vanes, a system for controlling pitch of the vanes and an oil transfer device. It is also aimed at the corresponding turbomachine as well as a method for mounting or dismounting the module.

### TECHNICAL BACKGROUND

The technical background is illustrated in the following documents WO-A1-2020/074816, EP-A1-3179044, FR-A1-3075881, EP-A1-3205576 et FR-A1-3087233.

The turbomachines generally comprise a ducted fan or an unducted propeller equipped with variable pitch movable vanes. A ducted fan provided with variable pitch vanes allows the pitch or the orientation of the blades of the vanes to be adjusted according to the flight parameters so as to optimize the operation of the fan. This configuration allows to optimize the module in which such a fan is integrated. As a reminder, the pitch angle of a blade corresponds to the angle, in a longitudinal plane perpendicular to the axis of rotation of the blade, between the chord of the blade and the plane of rotation of the fan. The variable pitch vanes can occupy a position referred to as reverse thrust in which they allow to generate a counter-thrust to help slow down the aircraft and a feathering position in which, in the event of failure or breakdown, they limit their resistance. The vanes of the fan are driven in rotation by an engine shaft. Such an example of a fan with variable pitch vanes is described in the patent application FR-A1-3087233.

The turbomachines with unducted propellers are known as “open rotor” or “unducted fan”. In this category of turbomachine, there are those with two unducted and counter-rotating propellers (known as UDF for “Unducted Dual Fan”) or those with a single unducted propeller and a straightener comprising several stator vanes (known as USF for “Unducted Single Fan”). The propeller or the propellers forming the propulsion portion may be placed at the rear of the gas generator (or engine) so as to be of the pusher type or at the front of the gas generator so as to be of the puller type. These turbomachines are turboprop engines that differ from turbojet engines by the use of a propeller outside the nacelle (unducted) instead of an internal fan presented above. This allows to increase the bypass ratio very significantly without being penalized by the mass of the casings or nacelles intended to surround the blades of the propeller or fan. The variable pitch allows for the same purpose to brake the aircraft or to limit the resistance in case of failure.

Currently, whether it is the ducted fans or the unducted propellers with variable pitch vanes, the pitch change system comprises a control means which is connected on the one hand, to a fan shaft which is typically driven by the engine shaft via a speed reducer and on the other hand, to a connection mechanism coupled to the variable pitch vanes. The control means, located in a rotating reference frame of the turbomachine, generally comprises a movable body which, by displacing, acts on the position of the blades of the variable pitch vanes. The control means is fed with a lubricating fluid, the feed source of which is arranged in a stationary reference frame of the turbomachine. A fluid transfer device to allow the passage from the stationary reference frame to the rotating reference frame is typically arranged downstream of the speed reducer involving a complex arrangement and a risk of leaks of the lubricant. This also causes wear on the parts of the fluid transfer device, which reduces the service life.

In addition, fan vanes of the fan are nowadays of large diameters to increase the bypass ratio of the turbomachines. However, with the pitch change system and the large diameter of the fan, the mass of the fan rotor is significant and can affect the stability of the same during the rotation. This instability problem can also induce to oil leaks at the level of the control means and in the entire lubrication enclosure.

### SUMMARY OF THE INVENTION

The objective of the present invention is to provide a turbomachine module equipped with variable pitch vanes that allows to reduce the risks of lubricant leaks while allowing a gain in compactness and being economical.

We achieve this objective in accordance with the invention by means of a turbomachine module with a longitudinal axis, comprising:
a fan intended to be driven in rotation about the longitudinal axis X by a fan shaft, the fan comprising a plurality of variable pitch fan vanes each being adapted to pivot about a pitch axis,
a speed reducer connected to the fan shaft, which is guided in rotation by at least one first rolling guide bearing and a second rolling guide bearing, which are located upstream of the speed reducer,
a pitch change system for the fan vanes comprising a connection mechanism connected to the vanes of the fan and a control means acting on the connection mechanism, the control means being arranged upstream of the speed reducer and comprising an annular body integral in rotation with the fan shaft and a movable body which is movable with respect to said annular body, which is connected to the connection mechanism,
a fluid transfer device which is configured to feed the control means and which is mounted on the control means,
the speed reducer has a planetary gear train, and in that the fluid transfer device is arranged upstream of the speed reducer and comprises a stator portion integral with a stationary structure of the turbomachine and a rotor portion engaged in the stator portion, the rotor portion being integral in rotation with the annular body of the control means, the control means being arranged upstream of the first and second guide bearings.

Thus, this solution allows to achieve the above-mentioned objective. In particular, the speed reducer with planetary gear train allows the integration of the fluid transfer device upstream the speed reducer, i.e. in a rotating reference frame of the turbomachine. This configuration allows to limit the leaks of fluid (oil) in the transfer device, to limit the thermal losses due to the heating of the oil by its shearing and to increase the service life of the fluid transfer device. On the other hand, the upstream mounting of the speed reducer and in particular on the control means allows easy and quick access to the transfer device for its maintenance under the wing of the aircraft. On the other hand, with a less complex integration, the bulk is reduced and the mounting/dismounting of the assembly is operated quickly. This reduces the intervention time as well as the cost of these interventions by the operators and the immobilization of the aircraft at the airports.

The module also comprises one or more of the following characteristics, taken alone or in combination:
the speed reducer comprises a planet carrier that is immovable in rotation and a ring gear that is coupled to the fan shaft.
the first guide bearing and the second guide bearing are placed with respect to each other at a predetermined distance from the longitudinal axis.
the second guide bearing is located upstream of the first guide bearing and the second guide bearing has an external diameter smaller than the external diameter of the first bearing.
the first guide bearing is placed downstream of the pitch axis of the fan vanes and the second guide bearing is placed upstream of the pitch axis.
the second guide bearing is placed close to the pitch axis of the fan vanes with a predetermined maximum distance between the pitch axis and an axis of the second bearing passing through a median plane of the axial length of the bearing.
the annular body comprises a downstream face in which is defined a hole that is centred on the longitudinal axis and the rotor portion of the transfer device comprises an upstream end that is housed in the hole.
the annular body comprises a radial flange extending around the downstream face and which is attached to a radial flange of the rotor portion of the fluid transfer device, a sealing wall extending at least partly between the radial flanges and comprising an external edge in sealing contact with a cylindrical internal wall of the fan shaft.
the fluid transfer device extends at least partly within the fan shaft.
the stator portion of the fluid transfer device is attached to the planet carrier through which at least one first feed channel and a second feed channel pass.
the control means comprises a first chamber and a second chamber of variable volumes, and feeding means for feeding the first and second chambers which are formed in the annular body, the feeding means comprising at least one first conduit opening into the first chamber and at least one second conduit opening into the second chamber, the first conduit and the second conduit also opening into the downstream face of the annular body.
the stator portion comprises an internal cylindrical surface and first pipelines opening into the internal cylindrical surface, the rotor portion comprising an external cylindrical surface into which second pipelines open, the second pipelines being coupled with the first and second conduits of the annular body respectively.
the movable body displaces in translation along the longitudinal axis.
the speed reducer comprises an inner planetary, planet gears, a planet carrier that carries the planet gears and an outer ring gear.
the inner planetary is coupled to the power shaft.
the speed reducer is housed in a lubrication enclosure.
at least one rotational guide bearing for a vane root is housed in an internal housing of an annulus.
the module comprises an annular part having a generally bell-shaped form, the annular part having a segment integral with the movable body of the control means and a flange integral with the connection mechanism, the annular part extending at least partly radially outwardly from the annular body.
the fluid transfer device is connected to a feed source located downstream of the speed reducer.
the fluid transfer device is an oil transfer device.
the second pipelines of the rotor portion are in fluidic communication with the first pipelines of the stator portion.
a sealing system is mounted between the transfer device and the control means so as to prevent oil leaks towards the control means.
the pitch change system comprises an annular part being general bell shaped and connecting the connecting mechanism to the control means, the annular part extending radially outside the control means. The invention further relates to an aircraft turbomachine comprising at least one turbomachine module having any of the foregoing characteristics.

The invention further relates to an aircraft comprising at least one turbomachine as above-mentioned.

The invention also relates to a method for mounting the module as aforesaid, the method comprising a step of attaching the fluid transfer device to the control means and a step of placing the control means in the fan rotor.

### BRIEF DESCRIPTION OF THE FIGURES

The invention will be better understood, and other purposes, details, characteristics and advantages thereof will become clearer upon reading the following detailed explanatory description of embodiments of the invention given as purely illustrative and non-limiting examples, with reference to the appended schematic drawings in which:

FIG. 1 is a schematic view, in axial and partial cross-section, of an example of a turbomachine with a ducted fan to which the invention applies;

FIG. 2 shows schematically, in partial axial cross-section, a variable pitch movable vane and a pitch change system for the same arranged in a fan rotor according to the invention;

FIG. 3 schematically illustrates the fan rotor and a fluid feed system of a control means equipping a change system of the pitch of the vanes of the fan according to the invention;

FIG. 4 is a perspective view of an oil transfer device between a stationary reference frame and a rotating reference frame of the turbomachine, the transfer device being mounted on a downstream face of a control means equipping a pitch change system according to the invention;

FIG. 5 shows schematically an example of a guide bearing arrangement of a fan shaft and an example of an oil transfer device arranged inside the fan shaft according to the invention; and

FIG. 6 represents the steps of a method for mounting the turbomachine module according to the invention.

### DETAILED DESCRIPTION OF THE INVENTION

The invention applies to a turbomachine intended to be mounted on an aircraft. The aircraft comprises a fuselage and at least two wings extending on either side of the fuselage along the axis of the fuselage. At least one turbomachine is mounted under each wing. The turbomachine can be a turbojet engine, for example a turbomachine equipped with a ducted fan (turbofan) or a turboprop engine, for example a turbomachine equipped with an unducted propeller (“open rotor”, “USF” for “Unducted Single Fan” or “UDF” for “Unducted Dual Fan”). Of course, the invention is applicable to other types of turbomachine.

In general and in the following description, the term “fan” is used to designate either a fan or a propeller.

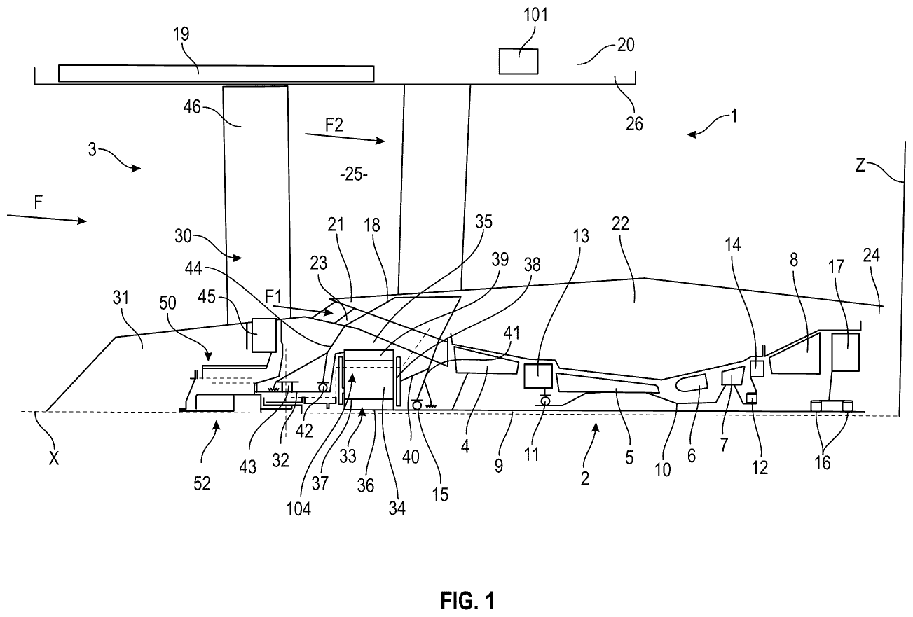

In the present invention, and in general, the terms “upstream”, “downstream”, “axial” and “axially” are defined in relation to the flow of the gases in the turbomachine and here along the longitudinal axis X (and even from left to right in FIG. 1). Similarly, the terms “radial”, “radially”, “internal”, “inner”, “external”, and “outer” are defined with respect to a radial axis Z perpendicular to the longitudinal axis X and with respect to the distance from the longitudinal axis X.

To facilitate its manufacture and its assembling/mounting/dismounting, a turbomachine is generally modular, i.e. it comprises several modules that are manufactured independently of each other and then assembled together. The modularity of a turbomachine also facilitates its maintenance. In the present application, we mean by “turbomachine module”, a module that comprises in particular a fan and a fan shaft for driving the fan.

In FIG. 1, the turbomachine 1 comprises a gas generator 2 with a fan 3 mounted upstream. The gas generator 2 typically comprises, from upstream to downstream, a low-pressure compressor 4, a high-pressure compressor 5, a combustion chamber 6, a high-pressure turbine 7 and a low-pressure turbine 8. The rotors of the low-pressure compressor 4 and the low-pressure turbine 8 are mechanically connected by a low-pressure shaft 9 so as to form a low-pressure body. The rotors of the high-pressure compressor 5 and the high-pressure turbine 7 are mechanically connected by a high-pressure shaft 10 so as to form a high-pressure body. The high-pressure body is guided in rotation about the longitudinal axis by a first rolling bearing 11 upstream and a second rolling bearing 12 downstream. The first bearing 11 is mounted radially between an inter-compressor casing 13 and an upstream end of the high-pressure shaft 10. The inter-compressor casing 13 is arranged axially between the low pressure 4 and high pressure 5 compressors. The second bearing 12 is mounted radially between an inter-turbine casing 14 and a downstream end of the high-pressure shaft 10. The inter-turbine casing 14 is arranged axially between the low pressure 7 and high pressure 8 turbines. The low-pressure body is guided in rotation about the longitudinal axis X via a third rolling bearing 15 and a fourth double rolling bearing 16. The latter are mounted radially between an exhaust casing 17 and a downstream end of the low-pressure shaft 9. The exhaust casing 17 is located downstream of the low-pressure turbine 8. The first bearing 15 is mounted radially between an inlet casing 18 and an upstream end of the low-pressure shaft 9. The high-pressure shaft 10 extends radially at least partly outside the low-pressure shaft 9 and are coaxial.

In another configuration not shown, the low-pressure or weak-pressure body comprises the low-pressure compressor which is connected to an intermediate pressure turbine. A free power turbine is mounted downstream of the intermediate pressure turbine and is connected to the propeller described below via a power transmission shaft to drive it in rotation.

The fan 3 is here ducted in a fan casing 19 which carries (with stator vanes mounted downstream of the fan) a nacelle 20. The fan 3 compresses an air flow that enters the turbomachine by dividing into a primary air flow F1 and a secondary air flow F2 at the level of a splitter nose 21. The latter is carried by the inlet casing 18 centred on the longitudinal axis X. The inlet casing 18 is extended downstream by an external casing or inter-duct casing 22. The primary air flow F1 circulates in a primary duct 23 which passes through the gas generator 2 and escapes through a primary nozzle 24. The secondary air flow F2 circulates in a secondary duct 25 and escapes through a secondary nozzle 26. The primary duct 23 and the secondary duct 25 are separated by the inter-duct casing 22.

The fan 3 comprises a series of the fan vanes 30 extending radially around a fan rotor 31. A cylindrical fan shaft 32 passes through the fan rotor 31, centred on the longitudinal axis X. The fan shaft 32 drives in rotation the fan rotor 31 about the longitudinal axis X. The fan shaft 32 is itself driven in rotation by a power transmission shaft of longitudinal axis X via a power transmission mechanism 33. In this example, the power transmission shaft is the low-pressure shaft 9. The fan shaft 32 and the low-pressure shaft 9 are coaxial. Alternatively, the power shaft is a power turbine shaft fed with gas by the gas generator 2.

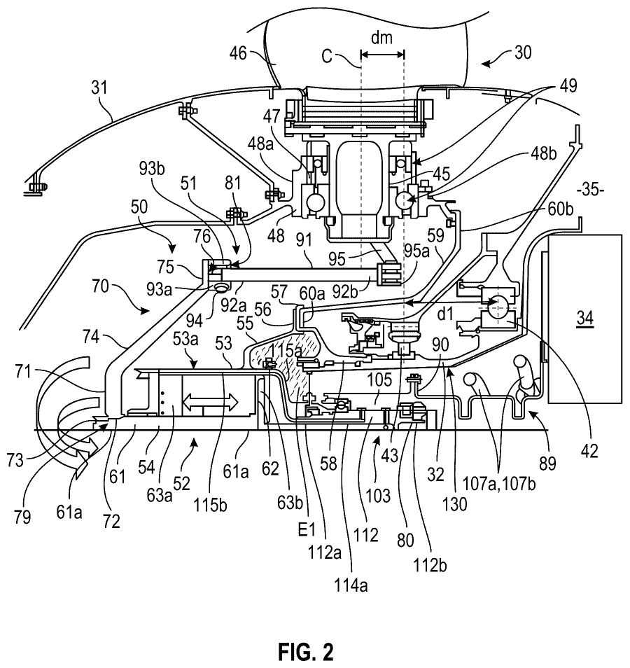

With reference to FIGS. 1 and 2, the power transmission mechanism 33 is a mechanical speed reducer 34 allowing to reduce the rotational speed of the fan shaft 32 relative to the speed of the low-pressure shaft 9. On the other hand, the speed reducer 34 allows the arrangement of a fan with a large diameter so as to increase the bypass ratio. The reducer 34 is of the planetary gear train type. The latter is housed in a lubrication enclosure 35 in which the same is lubricated. The speed reducer is connected to the fan shaft 32. Typically, the speed reducer 34 comprises an inner (or sun gear) planetary 36, planet gears 37, a planet carrier 38 and an outer ring gear 39 (outer planetary). In the present example, the planetary 36 is centred on the longitudinal axis X and is coupled in rotation with the power shaft (here the low-pressure shaft 9) along the longitudinal axis X. The latter comprises first elements intended to cooperate with second complementary coupling elements carried by the inner planetary 36. The planet gears 37 (in the form of pinions) are carried by the planet carrier 38 and each rotate about an axis substantially parallel to the longitudinal axis X. Each of the planet gears 37 meshes with the inner planetary 36 and the outer ring gear 39. The planet gears 37 are arranged radially between the inner planetary 36 and the outer ring gear 39. In this example, there are three planet gears 37. Of course, the speed reducer 34 may comprise a number of planet gears greater than three.

Advantageously, the outer ring gear 39 is coupled in rotation with the fan shaft 32. The ring gear 39 is centred on the longitudinal axis. In this way, the inner planetary 36 forms the input of the speed reducer 34 while the outer ring gear 39 forms the output of the same. On the other hand, the planet carrier 38 is stationary in relation to the ring gear 39. In particular, the planet carrier 38 is attached to a stationary structure of the turbomachine via a support ferrule 40. The latter is rigidly attached to the inlet casing 18 of the turbomachine in this embodiment. The support ferrule 40 is also attached to a first bearing support 41, stationary, that is integral with the inlet casing 18. Alternatively, the planet carrier 38 is attached to a radially internal ferrule of the inlet casing 18 or directly to a bearing support 44. This bearing support 44 described below is installed upstream of the speed reducer.

Advantageously, the third bearing 15 is mounted downstream of the speed reducer 34. Rolling guide bearings are also arranged upstream of the speed reducer 34 to guide the fan shaft 32 in rotation. These bearings are also arranged in the lubrication enclosure 35.

We can also see on FIGS. 1 and 2, a first rolling guide bearing 42 which is arranged just upstream of the speed reducer 34. This bearing 42 comprises an internal ring carried by the fan shaft 32 and the external ring is carried by a first base plate of the bearing support 44. The rolling-elements of the bearing 42 are balls. A second rolling guide bearing 43 is arranged upstream of the bearing 42. The external ring of the bearing 43 is carried by a second base plate of the bearing support 44. The internal ring of the bearing 43 is carried by the fan shaft 32. The bearing support 44 is stationary and is integral with the inlet casing 18.

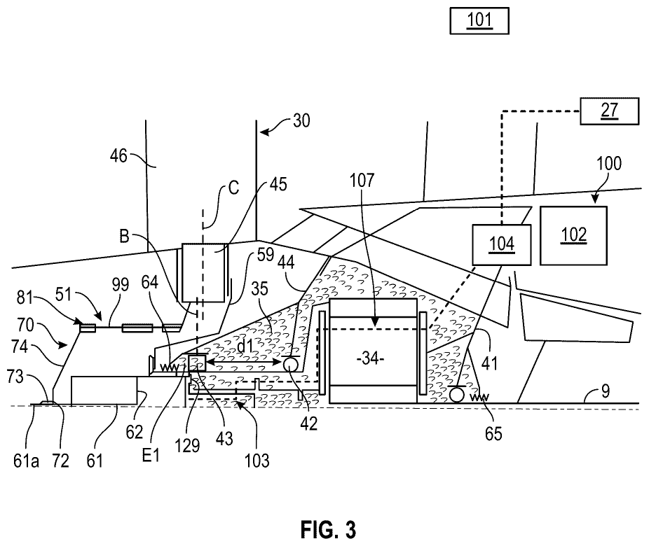

In FIGS. 2 and 3, the first and second guide bearings 42, 43 are positioned relative to each other at a predetermined distance d1 from the longitudinal axis. Such a configuration allows to ensure a dynamic stability of the fan vanes 30 during operation of the turbomachine because the diameter of the fan vanes is large. This also allows to reduce the clearances at the level of the fan shaft. The predetermined distance is at least 100 mm. Preferably, the predetermined distance is at least 150 mm or at least 170 mm.

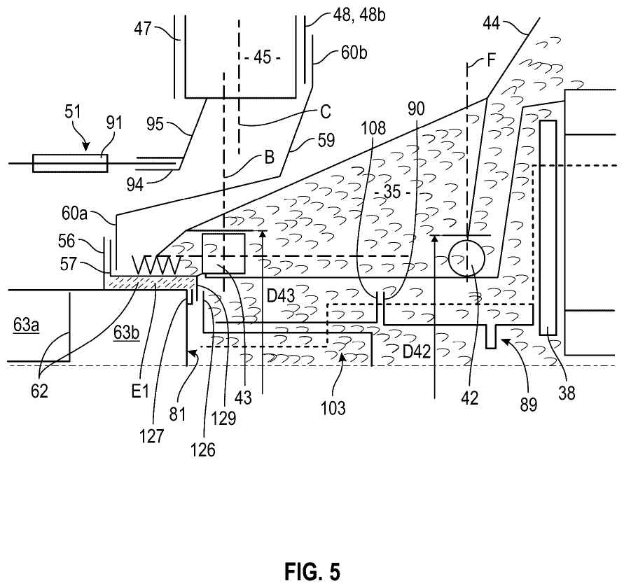

Advantageously, and more specifically illustrated in FIG. 5, the second guide bearing 43 has an external diameter D43 smaller than the external diameter D42 of the first guide bearing 42. Such a configuration allows the second bearing to be moved away from the first bearing (which is ball bearing) so as to reduce the bending of the fan shaft 32 (thus the misalignments). This also allows to reduce the overhang at the level of the upstream end of the fan shaft 32.

With reference to FIG. 2, the fan vanes 30 are variable pitch. Each fan vane 30 comprises a root 45 and a blade 46 extending radially outward from the root 45. In the example shown in FIG. 1, the free end of the blades is radially delimited by the fan casing 19. The root 45 of each vane 30 is typically in the form of a shaft or sleeve that is pivotally mounted along a pitch axis C in an internal housing 47 of an annulus 48. Alternatively, the root and the blade are separate, with the blade fitting into the root via a dovetail connection. The annulus 48 is integral with the fan rotor 31, is centred on the longitudinal axis and comprises several housings 47 evenly distributed around the axis X. There are as many housings as there are vane roots. The pitch axis C is parallel to the radial axis. The shaft of the root 45 is pivotally mounted by means of two guide bearings 49 mounted in each housing 47 and in a superimposed manner along the radial axis Z. These bearings 49 are preferably, but not restrictively, rolling bearings. The rolling-elements of these two bearings 49 comprise here balls respectively.

According to an example of embodiment shown in FIG. 3, the first guide bearing 42 is located downstream of the pitch axis C of the fan vanes 30 and the second guide bearing 43 is located upstream of the pitch axis. In this way, the lever arm is avoided and the fan rotor has a tolerance in rotation.

According to another example of embodiment of the arrangement of the pitch axis in relation to the bearings and such as illustrated in FIGS. 1 and 2, the second guide bearing 43 is located downstream of the pitch axis. In this case, the second guide bearing 43 is placed close to the pitch axis of the fan vanes. In this way, the lever arm is limited. In particular, the guide bearing 43 has an axis B passing through a median plane of the axial length of the bearing which is located at a predetermined maximum distance (dm) from the pitch axis. Such a distance is between 10 mm and 50 mm.

The pitch of the fan vanes is made by means of a pitch change system 50 installed in the fan rotor 31. The same is arranged in particular upstream of the speed reducer 34. The pitch change system 50 comprises at least one connection mechanism 51 connected to the fan vanes 30 and a control means 52 acting on the connection mechanism 51.

The control means 52 comprises a stationary, annular body 53 and a movable body 54 which is movable relative to the annular body 53. Advantageously, but not restrictively, the control means 52 is a linear actuator with an axis coaxial to the longitudinal axis X. The annular body 53 is integral in rotation with the fan shaft 32. The movable body 54 displaces in translation along the longitudinal axis X with respect to the annular body 53. The annular body 53 is therefore rotating but not translating. Even more specifically and according to this embodiment, the annular body 53 is cylindrical, centred on the axis X, and circular in cross-section. Such a configuration allows to limit the bulk of the control means in the fan rotor 31 both axially and radially. The annular body 53 extends radially around the movable body 54.

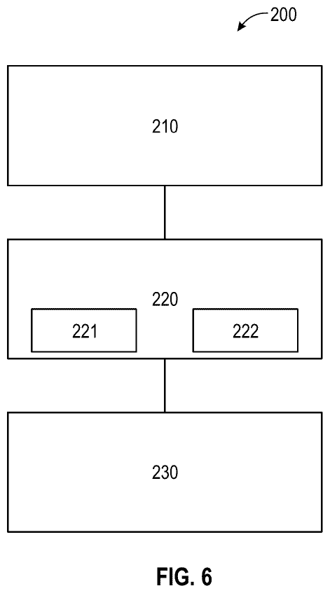

In FIGS. 2 and 6, the annular body 53 comprises advantageously, but non-restrictively, a first flange 56 that is attached to a second flange 57 of a trunnion 58. In particular, the annular body comprises a ferrule 55 that extends radially outward from an external surface 53a of the annular body 53. The ferrule 55 comprises the first flange 56 forming its free end. The trunnion 58 is attached to the external wall of the fan shaft 32 with suitable attachment elements. The annulus 48 retaining the vanes is also connected to the fan shaft 32 by means of a rotatable fan cone 59. To this end, the fan cone 59 comprises a third radial flange 60a that is attached to the flange 57 of the trunnion. The three flanges 56, 57 and 60a are attached together by attachment members such as screws, nuts, bolts, studs or analogous elements. As shown in FIG. 2, the flange 57 is installed axially between the flange 56 and the flange 60a. The fan cone 59 further comprises a radial tab 60b that is attached to a downstream flank 48b of the annulus 48. The attachment of the fan cone 59 downstream of the annulus 48 allows the integration of the connection mechanism and to reduce the axial bulk. The annulus 48 also comprises an upstream flank 48a (axially opposite the downstream flank 48b) that is attached to the fan rotor 31. By connecting the annular body 53 to the fan rotor (annulus 48 in particular), the forces transmitted from the fan rotor to the control means and to a fluid transfer device described later in the description are avoided. Here, the force path passes directly from the fan cone 59 to the fan shaft 32 and to the guide bearings 42, 43 of the fan shaft.

In the present example, the control means is a cylinder equipped with a case and a piston movable in a volume formed by the case. In particular, the movable body 54 is in the form of an axial rod 61 of a piston that extends between a first end 61a and a second end 61b. The movable body 54 further comprises a radial wall 62 that extends radially outward from an external face and around the rod 61. The annular wall 62 is located at the level of the second end 61b of the rod. This annular wall 62 allows to delimit two chambers 63a, 63b of variable volume in the annular body 53 and which are axially opposed. The movable body 54 displaces axially under the action of a control of the control means 52, and in particular of the pressure of a fluid circulating in each chamber 63a, 63b. To this end, the pitch change system 50 comprises feeding means ensuring the control of the same, described later in the description. The fluid received in the chambers 63a, 63b is for example a pressurized hydraulic fluid, from a fluidic feed system, so that the movable body 54 occupies at least two positions. Of course, the movable body 54 occupies several intermediate positions according to the different phases of flight of the aircraft. These two positions correspond respectively to the reverse thrust position and the feathering position of the variable pitch vanes. The displacement of the movable body 54 along the longitudinal axis X causes the movement of the connection mechanism 51, so that the same generates the pivoting and the pitch of the blades of the vanes about the pitch axis C.

In FIG. 3, the pitch change system 50 comprises an annular part 70 that has a general bell shape and that allows to connect the connection mechanism 51 to the control means 52. In other words, the annular part 70 is kinematically arranged between the movable body 54 and the connection mechanism 51. As illustrated, the annular part 70 extends radially outwardly from the annular body 54. In particular, the annular part 70 comprises a proximal segment 71 that is integral with the movable body 54 of the control means 52. Coupling means 79 are advantageously arranged between the movable body 54 and the annular part 70 so that they are integral in displacement, and in particular in translation. The segment 71 is in the form of a disc centred on the longitudinal axis X. The segment 71 comprises a central hole that extends through its wall on either side along the longitudinal axis X. The rod 61 of the movable body 54 extends at least partly through the central hole 72 of the segment 71 that is attached to the rod 61. The first end 61a of the rod extends upstream of the segment 71 and outside the annular part 70. The coupling means 79 (see FIG. 2) comprise first splines (not shown) that are formed on a radially external wall of the rod 61 and in the vicinity of the first end 61a. These first splines engage with corresponding second splines (not shown) on the segment 71. These second splines are formed on a radially internal wall of the central hole 72. A tightening member 73 such as a nut is mounted on the external wall of the rod 61 and against the segment 71. The tightening member 73 allows to axially lock the segment 71 on the rod 61. The annular part 70 comprises a central segment 74 that has a first end connected to the proximal segment 71 and that extends downstream by flaring out. The central segment 74 has a substantially frustoconical axial cross-section. The annular part 70 comprises advantageously a fourth flange 75 (shown specifically in FIG. 2) that extends radially outward from an external surface of the central segment 74. The flange 75 comprises attachment means 81, stationary, for the connection mechanism 51. The attachment means 81 extends substantially axially from a side face 76 of the flange 75.

The annular part 70 comprises a maximum internal diameter that is greater than the external diameter of the flange 56 of the annular body of the control means. This allows to facilitate the integration and the movements of the control means and of the connection mechanism.

According to an embodiment not shown, the annular part 70 is perforated so as to lighten the mass thereof and reduce the drag. In particular, through-slots, having an elongated shape, are made in the central segment 74 of the annular part 70.

In FIG. 2, the connection mechanism 51 comprises advantageously, but not restrictively, several links 91. One of the links is shown in this FIG. 2 for example. Each link 91 comprises a first end 92a and a second end 92b opposite each other along the direction of elongation of the link 91. The direction of elongation here is substantially parallel to the longitudinal axis (in the installation situation). The first end 92a is connected to the attachment means 81 integral with the annular part 70. The attachment means 81 comprise here clevises each formed by two ears 93a, 93b. The two ears of each clevis are passed through by a hinge axis 94 substantially parallel to the radial axis and around which a link 91 pivots. The second end 92b of each link 91 is articulated to a fork 95a provided at the free end of an arm 95 (see FIG. 2) connected to the root 45 of a fan vane. The arm 95 forms an eccentric. The links 91 are made of a metal material. There are as many links as there are fan vanes.

Advantageously, the links 91 are each adjustable in length. Typically, each link 91 comprises a threaded intermediate axis (not shown) extending between a first end and a second end. The first end of the intermediate axis is screwed into a threaded orifice in a first link segment (provided with one of the first and second ends 92a, 92b of the link). The second end of the intermediate axis is also screwed into a threaded orifice in a second link segment (along with the other of the first and second ends 92a, 92b of the link). This configuration allows to adjust the pitch of the vanes relative to each other. This allows for fine tuning of the pitches despite the manufacturing, tolerance and ageing defects that may affect the various parts making up the fan and the pitch change system. The annular ferrule 80 allows the adjustment to be maintained despite the dismounting of the control means 52 (cylinder).

With reference to FIG. 3 and as previously announced, the turbomachine comprises advantageously a fluidic feed system 100 allowing for distributing a lubricating fluid towards the various members and/or equipment that require it, such as the control means 52, the bearings, etc. Advantageously, the fluid is pressurized oil. The feed system 100 comprises a feed source 101 (or reservoir, illustrated schematically in FIGS. 1 and 5), a hydraulic pump 102 allowing for circulating the oil towards the members and/or equipment from the feed source 101, and a servo valve 104 allowing for regulating the oil pressure in the control means 52 according to the required pitch. The feed source 101 is arranged in a stationary reference frame on the turbomachine and generally in the nacelle 20 shown in FIG. 1 or in the inter-duct casing 22. The pump 102 and the servo valve 104 are also arranged in the stationary reference frame of the turbomachine. Advantageously, the pump 102 and the servo valve 104 are arranged in the inter-duct casing 22. The pump 102 may be driven by an accessory gear box (not shown), for example, which is mounted in the nacelle 20 or in the “core area” of the turbomachine. The “core area” is located in the inter-duct casing 22 (i.e. between the primary duct 23 and the secondary duct 25). In addition, the “core area” is considered as a fire area. Since the hydraulic cylinder is generally a fuel-operated cylinder, the cylinder can be kept within the fire area defined by the core area. As for the servo valve 104, it is electrically controlled by an electronic control unit 27 of the turbomachine which is known under the acronym “ECU”.

With reference to FIG. 2, the turbomachine comprises a fluid transfer device 103 between a stator and a rotor mounted in the feed system. With the control means 52 located in a rotating reference frame, the fluid transfer device 103 or oil transfer bearing allows oil to transfer oil from the stationary reference frame to the rotating reference frame of the turbomachine 1. This transfer device 103 is known as “OTB” for “Oil Transfer Bearing”. The fluid transfer device 103 is arranged upstream of the speed reducer 34 as shown in FIG. 2. The location of the fluid transfer device 103 is advantageous because it allows for easy dismounting/mounting without affecting the speed reducer. The feed system 100 also comprises a plurality of feed channels for delivering oil towards the members and/or equipment. The channels are connected to the servo valve 104. In FIG. 2, a first channel 107a and a second channel 107b (shown partially) pass through the planet carrier 38 and are connected to the oil transfer device 103. The planet carrier 38, rotationally immovable, allows the passage of the channels 107a, 107b through it and into the fan shaft 32.

In FIGS. 2 and 3, the transfer device 103 extends inside the fan shaft 32 (which is hollow) so as to reduce the axial and radial bulk. In particular, the bulk is advantageously reduced upstream where the control means 52 is located. The device 103 comprises a stator portion 105 and a rotor portion 112. The stator portion 105 is mounted integral with a stationary structure of the turbomachine. In the present example, the stator portion 105 is attached to the planet carrier 38 via a tubular element 89. The latter is configured so as to provide a “flexible connection” between the stator portion 105 and the planet carrier 38 here. This reduces the risk of misalignment and constraints between the rotor portion and the stator portion. For the same purpose, the first channel 107a and the second channel 107b are arranged in a “corkscrew” manner so as to manage the misalignments induced by the speed reducer 34. Other feed systems for the transfer device 103 may be considered to allow degrees of freedom between the same and the speed reducer and accommodate their relative displacements.

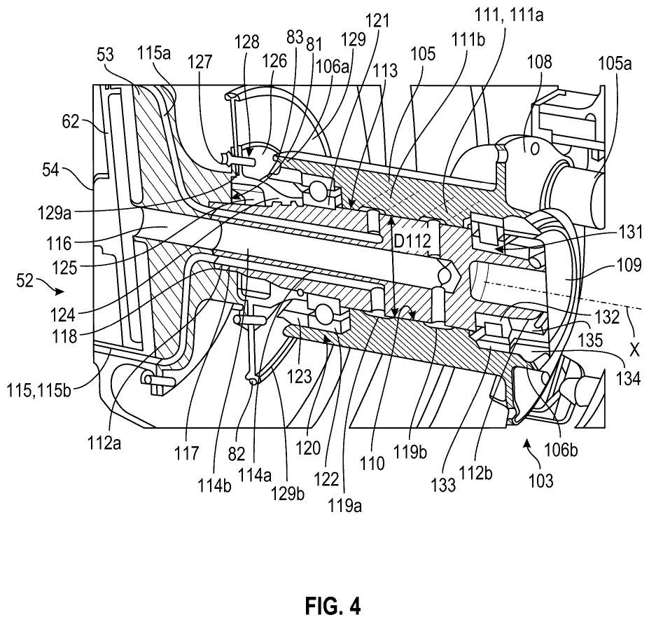

In FIG. 4, the stator portion 105 is cylindrical and centred on the longitudinal axis X. More specifically, the stator portion 105 extends between a first end 106a and a second end 106b along the longitudinal axis X. The stator portion 105 comprises a bottom wall 109 that is located at the second end 106b. The first end 106a is open and opens inside the stator portion 105 into a central bore that is delimited by an internal cylindrical surface 110. The stator portion 105 comprises a seventh radial flange 108 that extends radially outward from the cylindrical external surface of the stator portion 105. The flange 108 is attached to a collar 90 (see FIG. 2) of the tubular element 89 via attachment members such as pins 80 or screws and nuts. The pins 80 prevent the rotation of the stator portion in relation to the rotor portion.

The stator portion 105 comprises first pipelines 111 that open into the cylindrical internal surface 110. Advantageously, but not restrictively, the stator portion 105 comprises two first pipelines 111a, 111b (shown in dotted line in FIG. 4) that extend through the thickness of the stator portion. These second pipelines are annular. The stator portion 105 also comprises a first port 105a that extends from an external cylindrical surface of the stator portion. The first port 105a is connected to one end of the first channel 107a. The stator portion 105 also comprises a second port 105b extending from the external cylindrical surface thereof and which is connected to the second channel 107b.

In FIG. 4, the rotor portion 112 is engaged inside the stator portion 105. The rotor portion when mounted within the stator portion 105 forms an assembly (or a cartridge) that is mounted on the control means 52. The rotor portion 112 also has a cylindrical shape. The rotor portion 112 extends along the longitudinal axis X between an upstream end 112a and a downstream end 112b. The downstream end 112b faces the bottom wall 109 of the stator portion 105. The rotor portion 112 is rotatable inside the stator portion 105 along the longitudinal axis. The rotor portion 112 comprises an external cylindrical surface 113 facing the internal cylindrical surface 110 of the stator portion 105. The external diameter D112 of the internal cylindrical surface 110 is substantially equal to the diameter of the external cylindrical surface 113 (while allowing the rotor portion 112 to rotate in the stator portion 105).

The rotor portion 112 further comprises second pipelines 114 that each open into the external cylindrical surface 113 via orifices 119. These second pipelines 114 are in fluidic communication with the first pipelines 111a, 111b of the stator portion. The second pipelines 114 are fluidly connected with the feeding means of the control means 52. The second pipelines 114 comprise an external pipeline 114a extending through the thickness of the wall of the rotor portion 112. The external pipeline 114a comprises a radial segment that is coupled to an orifice 119a and an axial segment that extends in major part along the longitudinal axis X. The orifice 119a faces the first pipeline 111b, (here first upstream pipeline 111b). The axial segment of the external pipeline 114a opens into an upstream surface of the upstream end 112a of the rotor portion 112.

Advantageously, the external pipeline 114a is annular. Advantageously, but not restrictively, the external pipeline 114 is in the form of two semi-annular external pipelines. The second pipelines 114 comprise a central pipeline 114b that also extends through the thickness of the rotor portion 112. The central pipeline 114b comprises a radial segment that opens into an orifice 119b and a central segment that extends along the longitudinal axis. The orifice 119b faces the first pipeline 111a (here first downstream pipeline 111b). The central segment of the central pipeline 114b is coaxial with the axis of the rotor portion 112. The central segment opens into the upstream face of the upstream end 112a. The external pipeline 114a extends radially outward from the central, internal pipeline 114b.

The rotor portion 112 is integral in rotation with the control means 52, and here more particularly to the annular body 53 thereof. This allow, on the one hand, to provide a compact system and on the other hand, to facilitate the assembly and disassembly of the transfer device in relation to the control means. To this end, the annular body 53 comprises a downstream face 81 in which a hole 117 is defined. The hole 117 has a support bottom 118 that is defined in a plane perpendicular to the longitudinal axis. The upstream end 112a of the rotor portion is housed in the hole 117. The upstream face of the upstream end 112a is in abutment against the support surface 118. The rotor portion 112 also comprises a radial flange 126 that is attached to a radial flange 127 of the annular body 153. In particular, the radial flange 126 is integral with a sleeve 124 that is rigidly mounted on the rotor portion 112 at the level of the upstream end 112a of the rotor portion 112. The sleeve 124 has a hollow cylindrical body and the flange 126 extends radially outward from the body of the sleeve. The radial flange 127 of the annular body 53 extends radially around the downstream face 81. The flanges 126, 127 are attached together by attachment members 128 such as screws, nuts, or the analogous elements. Such an attachment allows either the control means 52 equipped with the fluid transfer device 103 to be mounted/dismounted, or the control means and the fluid transfer device to be mounted/dismounted independently.

With reference to FIGS. 4 and 5, a sealing system is mounted between the transfer device 103 and the control means 52 so as to avoid oil leaks towards the control means. The sealing system allows to create two distinct and hermetic enclosures, an upstream enclosure E1 (referenced in schematic FIG. 5) in which the control means 52 is arranged and a downstream enclosure which is the lubrication enclosure 35 in which at least the transfer device 103 is arranged. The sealing system comprises a wall 129 in the form of a disc defined in a plane perpendicular to the longitudinal axis X. The wall 129 comprises a central opening delimiting an internal edge 129a that is attached between the flanges 126, 127 via the attachment members 128. The wall 129 also comprises an external edge 129b that contacts a cylindrical internal wall 130 (referenced in FIG. 2) of the fan shaft 32. The external diameter of the wall 129 is substantially equal (+/−0.5 mm) to the minimum internal diameter of the fan shaft 32. An annular seal 82 is installed between the external edge 129b and the cylindrical internal wall 130. In the event of oil leak at the level of the control means, the oil is recovered in the upstream enclosure E1 shown in FIGS. 2 and 3 and which is delimited by the ferrule 55, the trunnion 58, a segment of the annular body 53 and the sealing wall 129.

In FIG. 3, the lubrication enclosure 35 is sealed by sealing means. These sealing means (shown schematically) comprise an upstream seal 64 mounted between the bearing support 44 and the fan shaft 32 and a downstream seal 65 mounted between the bearing support 41 and the low-pressure shaft 9.

With reference to FIG. 4, the feeding means of the control means 52 comprise conduits provided in the thickness of annular body 53. More precisely, the feeding means comprise a first conduit 115 which opens, on the one hand, into the downstream face 81 and, on the other hand, into the annular body 53. The first conduit 115 comprises a substantially radial segment 115a that is arranged downstream of the chambers 63a and 63b and an axial segment 115b that extends along the chambers 63a, 63b of the annular body 53. The axial segment 115b opens into the chamber 63a, upstream. The first conduit 115 is coupled to the external pipeline 114a. The feeding means comprises a second conduit 116 that extends along the longitudinal axis and is coaxial with the axis of the annular body. The conduit 116 opens into the downstream face and in particular into the hole 117. The hole 117 and the second conduit 116 are coaxial. The second conduit 116 also opens into the annular body and in particular into the chamber 63b. The second conduit 116 is coupled to the pipeline 114b (when the rotor portion is coupled to the control means). The second conduit 116 and the central pipeline 114b are coaxial and have a circular cross-section. These are also of the same diameter.

The rotor portion 112 is rotatably mounted with respect to the stator portion 105 by means of bearings. These bearings are arranged on either side of the orifices 119a, 119b so as to provide a hydrostatic sealing. Another sealing means is of course possible. In this example, a first bearing 120 is mounted upstream of the orifices 119a, 119b formed in the external cylindrical surface 113 and through which the pipelines 114a, 114b open. The first bearing 120 is with rolling. This comprises an internal ring 121 which is carried by the external cylindrical surface 113 and an external ring 122 which is carried by the internal cylindrical surface of the stator portion 105. The external ring 122 is axially blocked on the one hand, by a cylindrical bearing surface, and on the other hand, by a nut or a hoop 123. Between the hoop and a cylindrical internal surface segment, at the level of the end 106a is provided a sealing element such as an annular seal 83. The internal ring 121 is carried by the external cylindrical surface 110 of the rotor portion 112. The internal ring 121 is axially blocked on the one hand, by a cylindrical bearing surface and on the other hand, by the cylindrical sleeve 124. The cylindrical sleeve 124 is blocked upstream by a hoop or a nut 125. The rolling-elements mounted between the rings are balls.

A second bearing 131 is also mounted between the rotor portion 112 and the stator portion 105 of the transfer device. The second bearing 131 is also a rolling bearing. The rolling-elements of this bearing 131 are rollers. This bearing 131 is mounted downstream of the first bearing 120 and in particular downstream of the orifices formed in the external cylindrical surface 113. The second bearing 131 comprises an internal ring 132 and an external ring 133. The external ring 133 is carried by the internal cylindrical surface 113. The external ring 133 is axially blocked upstream by a cylindrical bearing surface and downstream by a hoop or a nut 134. The internal ring 132 is carried by the external cylindrical surface 113. The latter is blocked upstream by a cylindrical bearing surface and downstream by a hoop or a nut 135. The rolling-elements mounted between the rings are rollers.

In the present example, the external diameter of the first bearing 120 is greater than the external diameter of the second bearing 131. However, the external diameter of the first bearing is smaller than the external diameter of the annular body 53 of the control means 52. Thus, the diameter of this bearing 120 is smaller than those of the bearings of the prior art. This allows to reduce the clearance and limit the shearing of the oil, which on the one hand, reduces its heating and on the other hand, reduces the need for heat evacuation. Also, with this configuration, the first bearing 121 (with balls) does not take up any axial force (which allows to have rollings, in this case balls, of small dimensions). In addition, an oil transfer device with a small diameter (such as less than the diameter of the control means 52) could allow the diameter of the first and second bearings to be destressed (which will necessarily be mounted at a larger diameter).

Alternatively, the external diameters of the first and second bearings 120, 131 are substantially identical.

A method 200 for mounting the turbomachine module as described above will be described below. The steps of the mounting method 200 are shown in FIG. 6. In particular, the mounting method comprises a step of attaching 220 the fluid transfer device to the control means and a step of placing 230 the control means in the fan rotor. Prior to the attachment step 220, the method comprises a step 210 of assembling the transfer device. This step 210 comprises inserting or engaging the rotor portion 112 into the stator portion 105. The attachment step 220 comprises a sub-step 221 of inserting the upstream end 112a into the hole 117 located in the downstream face of the annular body 53. The step 220 also comprises a sub-step of attaching 222 the flanges 126 and 127. The sealing wall 129 is previously installed between the flanges 126, 127. During the placement step 220, the control means 52 equipped with the transfer device 103 is displaced downstream into the fan rotor. Next, the flange 108 is attached to the collar 90 of the previously installed tubular element 89. Then, the control means 52 is attached to the fan shaft 32 via the flanges 56, 57, 60a. The annular part 70 can be attached to the movable body 54 and to the links 91. In this way, the fluid, the oil, can circulate from the feed source 101 towards the control means 52 through the speed reducer 34 on the one hand, and through the fluid transfer device 103 on the other. The arrangement of the oil transfer device 103 upstream of the speed reducer 34 facilitates its mounting and the dismounting.

1. Turbomachine module with a longitudinal axis, comprising:
a fan intended to be driven in rotation about the longitudinal axis by a fan shaft, the fan comprising a plurality of variable pitch fan vanes each being adapted to pivot about a pitch axis,
a speed reducer connected to the fan shaft, which is guided in rotation by at least one first rolling guide bearing and a second rolling guide bearing, which are located upstream of the speed reducer,
a pitch change system for the vanes of the fan comprising a connection mechanism connected to the vanes of the fan and a control means acting on the connection mechanism, the control means being arranged upstream of the speed reducer being arranged upstream of the first and second guide bearings and comprising an annular body integral in rotation with the fan shaft and a movable body which is movable with respect to said annular body and which is connected to the connection mechanism,
a fluid transfer device which is configured to feed the control means,
wherein the speed reducer has a planetary gear train, and in that the fluid transfer device is arranged upstream of the speed reducer, and is mounted on the control means, and comprises a stator portion integral with a stationary structure of the turbomachine and a rotor portion engaged in the stator portion, the rotor portion being integral in rotation with the annular body of the control means.

2. Turbomachine module according to claim 1, wherein the speed reducer comprises a planet carrier that is immovable in rotation and a ring gear that is coupled to the fan shaft.

3. Turbomachine module according to claim 1, wherein the first guide bearing and the second guide bearing are placed with respect to each other at a predetermined distance from the longitudinal axis.

4. Turbomachine module according to claim 1, wherein the second guide bearing is located upstream of the first guide bearing and the second guide bearing has an external diameter smaller than the external diameter of the first bearing.

5. Turbomachine module according to claim 1, wherein the first guide bearing is placed downstream of the pitch axis of the vanes of the fan and the second guide bearing is placed upstream of the pitch axis.

6. Turbomachine module according to claim 1, wherein the second guide bearing is placed close to the pitch axis of the vanes of the fan with a predetermined maximum distance (dm) between the pitch axis and an axis of the second bearing passing through a median plane of the axial length of the bearing.

7. Turbomachine module according to claim 1, wherein the annular body comprises a downstream face in which is defined a hole that is centred on the longitudinal axis and the rotor portion of the transfer device comprises an upstream end that is housed in the hole.

8. Turbomachine module according to claim 7, wherein the annular body comprises a radial flange extending around the downstream face and which is attached to a radial flange of the rotor portion of the fluid transfer device, a sealing wall extending at least partly between the radial flanges and comprising an external edge in sealing contact with a cylindrical internal wall of the fan shaft.

9. Turbomachine module according to claim 1, wherein the fluid transfer device extends at least partly within the fan shaft.

10. Turbomachine module according to claim 2, wherein the stator portion of the fluid transfer device is attached to the planet carrier through which at least one first feed channel and a second feed channel pass.

11. Turbomachine module according to claim 7, wherein the control means comprises a first chamber and a second chamber of variable volume, and feeding means for feeding the first and second chambers which are formed in the annular body, the feeding means comprising at least one first conduit opening into the first chamber and at least one second conduit opening into the second chamber, the first conduit and the second conduit also opening into the downstream face of the annular body.

12. Turbomachine module according to claim 11, wherein the stator portion comprises an internal cylindrical surface and first pipelines opening into the internal cylindrical surface, the rotor portion comprising an external cylindrical surface into which second pipelines open, the second pipelines being coupled respectively with the first and second conduits of the annular body.

13. Turbomachine module according to claim 1, wherein the movable body displaces in translation along the longitudinal axis.

14. Turbomachine module according to claim 1, wherein the pitch change system comprises an annular part being generally bell-shaped and connecting the connection mechanism to the control means, the annular part extending at least partly radially outwardly from the stationary body.

15. Aircraft turbomachine comprising at least one turbomachine module according to claim 1.
